(19) United States
(12) Patent Application Publication
(10) Pub. No.: US 2025/0106416 A1
(43) Pub. Date: Mar. 27, 2025

(54) COMPRESSED DOMAIN ARTIFICIAL INTELLIGENCE FOR IMAGE SIGNAL PROCESSING

(71) Applicant: Samsung Electronics Co., Ltd., Suwon-si (KR)

(72) Inventors: Molin Zhang, Santa Clara, CA (US); Soumendu Majee, Plano, TX (US); Chengyu Wang, Plano, TX (US); John Seokjun Lee, Plano, TX (US); Hamid Rahim Sheikh, Plano, TX (US)

(21) Appl. No.: 18/816,846

(22) Filed: Aug. 27, 2024

Related U.S. Application Data
(60) Provisional application No. 63/539,936, filed on Sep. 22, 2023.
(60) Provisional application No. 63/539,949, filed on Sep. 22, 2023.
(60) Provisional application No. 63/545,249, filed on Oct. 23, 2023.
(60) Provisional application No. 63/545,252, filed on Oct. 23, 2023.

(51) Int. Cl. H04N 19/42; H04N 9/64; H04N 19/172; H04N 19/184

(52) U.S. Cl. CPC H04N 19/42; H04N 9/64; H04N 19/172; H04N 19/184

(57) ABSTRACT

A method includes obtaining a raw image and mapping, using a raw image encoder, the raw image to a compressed domain. The raw image is represented using latent variables in the compressed domain. The method also includes performing one or more image signal processing operations on the latent variables, where (i) each of the one or more image signal processing operations is configured to operate in the compressed domain and (ii) the one or more image signal processing operations generate processed latent variables. The method further includes mapping, using an output image decoder, the processed latent variables to an output image in an output color space.

### CROSS-REFERENCE TO RELATED APPLICATIONS AND PRIORITY CLAIM

This application claims priority under 35 U.S.C. § 119 (e) to U.S. Provisional Patent Application No. 63/539,936 filed on Sep. 22, 2023, U.S. Provisional Patent Application No. 63/539,949 filed on Sep. 22, 2023, U.S. Provisional Patent Application No. 63/545,249 filed on Oct. 23, 2023, and U.S. Provisional Patent Application No. 63/545,252 filed on Oct. 23, 2023. All of these provisional applications are hereby incorporated by reference in their entirety.

### TECHNICAL FIELD

This disclosure relates generally to image signal processing. More specifically, this disclosure relates to compressed domain artificial intelligence for image signal processing.

### BACKGROUND

As imaging resolutions of mobile devices have increased, memory requirements have become a bottleneck. One way to address that problem is to compress high-resolution images to a compressed domain with smaller size and perform downstream tasks, such as demosaicing and denoising, in this domain. However, designing an effective and general compression domain for downstream tasks remains challenging, and current techniques in image compression have limitations. For instance, most image compression processes are designed for red-green-blue (RGB) images rather than raw images, while raw data processing is essential in modern image signal processing (ISP). Applying image compression to raw data tends to reach a local minimum solution with inferior performance. Also, existing image compression techniques are not directly designed for compressed domain ISP downstream tasks.

### SUMMARY

This disclosure relates to compressed domain artificial intelligence for image signal processing.

In a first embodiment, a method includes obtaining a raw image and mapping, using a raw image encoder, the raw image to a compressed domain. The raw image is represented using latent variables in the compressed domain. The method also includes performing one or more image signal processing operations on the latent variables, where (i) each of the one or more image signal processing operations is configured to operate in the compressed domain and (ii) the one or more image signal processing operations generate processed latent variables. The method further includes mapping, using an output image decoder, the processed latent variables to an output image in an output color space.

In a second embodiment, an electronic device includes at least one processing device configured to obtain a raw image and map, using a raw image encoder, the raw image to a compressed domain. The raw image is represented using latent variables in the compressed domain. The at least one processing device is also configured to perform one or more image signal processing operations on the latent variables, where (i) each of the one or more image signal processing operations is configured to operate in the compressed domain and (ii) the one or more image signal processing operations are configured to generate processed latent variables. The at least one processing device is further configured to map, using an output image decoder, the processed latent variables to an output image in an output color space.

In a third embodiment, a non-transitory machine readable medium contains instructions that when executed cause at least one processor of an electronic device to obtain a raw image and map, using a raw image encoder, the raw image to a compressed domain. The raw image is represented using latent variables in the compressed domain. The non-transitory machine readable medium also contains instructions that when executed cause the at least one processor to perform one or more image signal processing operations on the latent variables, where (i) each of the one or more image signal processing operations is configured to operate in the compressed domain and (ii) the one or more image signal processing operations are configured to generate processed latent variables. The non-transitory machine readable medium further contains instructions that when executed cause the at least one processor to map, using an output image decoder, the processed latent variables to an output image in an output color space.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration providing compressed domain artificial intelligence (AI) for image signal processing (ISP) in accordance with this disclosure;

FIG. 2 illustrates an example process of using a compressed domain AI for image signal processing in accordance with this disclosure;

FIG. 3 illustrates an example architecture for derivation of a compressed domain for an AI model in accordance with this disclosure;

FIG. 4 illustrates an example architecture for a compressed domain for a number of different data formats for an AI model in accordance with this disclosure;

FIG. 5 illustrates an example architecture for operation of an AI model within a compressed domain in accordance with this disclosure;

FIG. 6 illustrates an example AI model for efficient raw domain compressed image data ISP in accordance with this disclosure;

FIG. 7 illustrates an example architecture for progressive compression-decompression for an AI model operating in the compressed domain in accordance with this disclosure;

FIGS. 8A through 8C comparatively illustrate example compression and inherent demosaicing for raw data when using a compressed domain AI for image signal processing in accordance with this disclosure;

FIGS. 9A through 9C comparatively illustrate example compression and inherent demosaicing for raw data when using a compressed domain AI for image signal processing using an enlargement of a portion of the image content from FIGS. 8A through 8C in accordance with this disclosure;

FIGS. 10A through 10C comparatively illustrate example raw image denoising in the compressed latent domain for image signal processing in accordance with this disclosure;

FIGS. 11A through 11C comparatively illustrate example multi-frame blending in the compressed domain for image signal processing in accordance with this disclosure;

FIGS. 12A and 12B illustrate example results of progressive encoding and decoding in accordance with this disclosure;

FIG. 13 illustrates another example AI model for efficient raw domain compressed image data ISP in accordance with this disclosure;

FIG. 14 illustrates an example architecture for generalized progressive compression-decompression for an AI model operating in the compressed domain in accordance with this disclosure;

FIG. 15 illustrates an example architecture for derivation of a compressed domain for an AI model utilizing generalized progressive compression-decompression in accordance with this disclosure;

FIG. 16 illustrates an example architecture for generalized progressive compression-decompression for an AI model in accordance with this disclosure;

FIGS. 17A through 17C comparatively illustrate example compression and inherent demosaicing for raw data when using a low-resolution decoder for a compressed domain AI performing image signal processing in accordance with this disclosure;

FIGS. 18A through 18C comparatively illustrate example raw image denoising using a low-resolution decoder for a compressed domain AI performing image signal processing in accordance with this disclosure;

FIGS. 19A through 19C comparatively illustrate example multi-frame blending using a low-resolution decoder for a compressed domain AI performing image signal processing in accordance with this disclosure;

FIGS. 20A through 20C comparatively illustrate example image registration using a low-resolution decoder for a compressed domain AI performing image signal processing in accordance with this disclosure;

FIG. 21 illustrates a typical multi-frame ISP pipeline;

FIG. 22 illustrates a specific example of a multi-frame ISP pipeline;

FIG. 23 illustrates a pipeline for the ISP sequence of FIG. 22 in the context of a compute engine and memory;

FIG. 24 illustrates a pipeline for the ISP sequence of FIG. 22 in the context of a compute engine and memory and assuming a specified data compression ratio;

FIG. 25 illustrates an example pipeline utilizing AI to compress data and performing AI-based processing on the compressed data in accordance with this disclosure;

FIG. 26 illustrates another example pipeline utilizing AI to compress data and performing AI-based processing on the compressed data in accordance with this disclosure;

FIG. 27 illustrates an example compressed domain AI multi-frame multi-task pipeline in accordance with this disclosure;

FIG. 28 illustrates an example pipeline utilizing progressive AI compression and using most significant bits to efficiently perform downstream tasks that do not need full-resolution data in accordance with this disclosure;

FIG. 29 illustrates another example pipeline utilizing progressive AI compression and using most significant bits to efficiently perform downstream tasks that do not need full-resolution data in accordance with this disclosure;

FIG. 30 illustrates an example pipeline utilizing AI to compress multi-frame data using temporal redundancy between frames in accordance with this disclosure;

FIGS. 31A through 31C comparatively illustrate an example result of multi-frame blending in a compressed domain for AI-based image signal processing in accordance with this disclosure;

FIGS. 32A through 32D comparatively illustrate an example result of compressed domain for AI denoising in accordance with this disclosure; and

FIGS. 33A through 33C comparatively illustrate an example result of compressed domain for AI registration in accordance with this disclosure.

### DETAILED DESCRIPTION

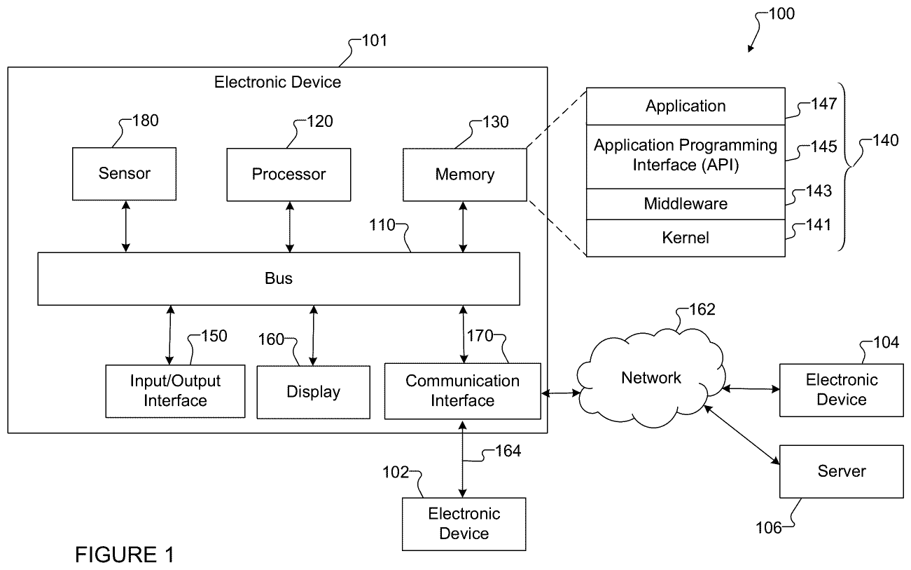

FIGS. 1 through 33C, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

FIG. 1 illustrates an example network configuration 100 providing compressed domain AI for image signal processing in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), or a graphics processor unit (GPU). The processor 120 is able to perform control on at least one of the other components of the electronic device 101 and/or perform an operation or data processing relating to communication or other functions. As described in more detail below, the processor 120 may perform various operations related to compressed domain artificial intelligence (AI) for image signal processing (ISP).

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support various functions related to compressed domain AI for image signal processing. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors for capturing images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the first external electronic device 102 or the second external electronic device 104 can be a wearable device or an electronic device-mountable wearable device (such as a head mounted display (or “HMD”)). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. The electronic device 101 can also be an augmented reality wearable device, such as eyeglasses, which include one or more imaging sensors, or a VR or XR headset.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support the electronic device 101 by performing at least one of operations (or functions) implemented on the electronic device 101. For example, the server 106 can include a processing module or processor that may support the processor 120 implemented in the electronic device 101. As described in more detail below, the server 106 may perform various operations related to compressed domain AI for image signal processing.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

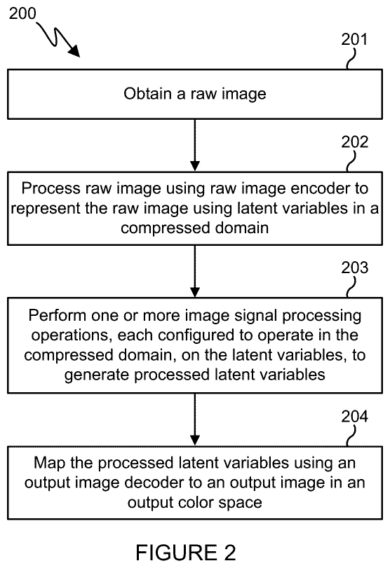

FIG. 2 illustrates an example process 200 of using a compressed domain AI for image signal processing in accordance with this disclosure. For case of explanation, the process 200 of FIG. 2 is described as being performed using the electronic device 101 in the network configuration 100 of FIG. 1. However, the process 200 may be performed using any other suitable device(s) and in any other suitable system(s).

As shown in FIG. 2, the process 200 starts with obtaining a raw image (step 201). The image may have any suitable resolution and image format. In some cases, the image may represent a Tetra format image, a (quad) Bayer format image, a hexa-deca Bayer (“hexa-deca”) format image, or a red-green-blue-white (RGBW) format image. Using a raw image encoder, the raw image is processed to a compressed domain in which the raw image is represented using latent variables in the compressed domain (step 202). In some cases, the raw image encoder may be a convolutional neural network-based encoder with quantization.

One or more image signal processing operations, each configured to operate in the compressed domain, are performed on the latent variables to generate processed latent variables (step 203). The one or more image signal processing operations may be used here to provide any suitable image processing functionality. In some cases, for instance, the image signal processing operation(s) may include compressed domain denoising, compressed domain sharpening, compressed domain point spread function (PSF) inversion, compressed domain segmentation, compressed domain motion map estimation and motion compensation, compressed domain motion image registration, or any combination thereof. Using an output image decoder, the processed latent variables are mapped to an output image in an output color space (step 204). The output image may have any suitable resolution and image format. In some cases, the output image may be mapped to a red-green-blue (RGB) color space or a luminance-chrominance (YUV) color space.

Although FIG. 2 illustrates one example of a process 200 of using a compressed domain AI for image signal processing, various changes may be made to FIG. 2. For example, while shown as a series of steps, various steps in FIG. 2 could overlap, occur in parallel, occur in a different order, or occur any number of times (including zero times).

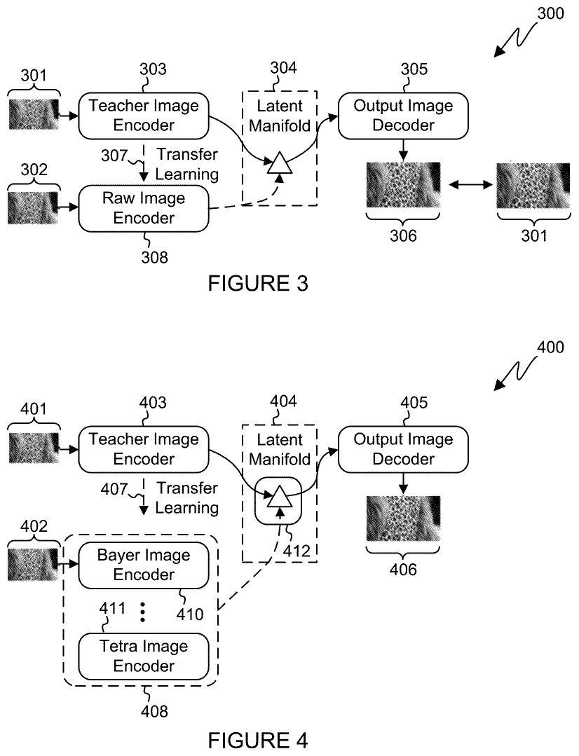

FIG. 3 illustrates an example architecture 300 for derivation of a compressed domain for an AI model in accordance with this disclosure. For case of explanation, the architecture 300 of FIG. 3 is described as being used by the electronic device 101 in the network configuration 100 of FIG. 1. However, the architecture 300 may be used by any other suitable device(s) and in any other suitable system(s).

As shown in FIG. 3, the architecture 300 can be used for deriving a compressed domain for an AI model using counterpart images, namely a teacher image 301 and a corresponding raw image 302 in this example. Note that the teacher image 301 in FIG. 3 may conform to any color space, such as an RGB color space, a YUV color space, a hue-saturation-value (HSV) color space, a hue-saturation-lightness (HSL) color space, a hue-saturation-brightness (HSB) color space, or a cyan-magenta-yellow (CMY) color space. As used herein, “teacher image” and “output image” (and similar counterpart terms) should be understood to use the same color space in a given embodiment. The raw image 302 can represent a raw data file format specific to a camera or other imaging system and may be, for example, a (quad) Bayer image, a (quad) Tetra image, a hexa-deca image, or an RGBW image. For purposes of this disclosure, while RGB may be used in various examples, any of a number of standardized color spaces, such as those based on a cross-platform color model in which visual perception is balanced against data size, may be used. Also, raw data generally refers to unprocessed or minimally processed data from an image sensor with (usually) large amounts of potentially redundant data.

Compared with raw images, RGB images (representative of one possible teacher image color space) contain more semantic information, which makes derivation of a compressed domain easier. Instead of directly designing a compressed domain by training a compression model for raw images, an external teacher model is introduced as shown in FIG. 3. More specifically, a trained teacher encoder 303 takes the teacher image 301 as an input and generates compressed latent variables for a latent manifold 304. A trained output decoder 305 generates an output image 306 (which utilizes the same color space as the teacher image 301) based on the latent variables within the latent manifold 304. Differences between the original teacher image 301 and the generated teacher image 306, such as reconstruction loss, generative adversarial network (GAN) loss, and/or perceptual loss, may be employed in refining the latent variables for the compressed latent manifold 304. As illustrated in FIG. 3, the whole architecture 300 follows an auto-encoder approach.

Via transfer learning 307, a raw image encoder 308 is employed to augment the latent variables within the latent manifold 304 to account for latent distance loss. Compared to directly training an encoder and decoder for raw images, this approach is less challenging. In addition, the design of the compressed domain (represented by the latent manifold 304) for the raw image 302 is highly supervised and benefits by the trained teacher encoder 303 and the trained output decoder 305.

Although FIG. 3 illustrates one example of an architecture 300 for derivation of a compressed domain for an AI model, various changes may be made to FIG. 3. For example, any suitable number of images 301 and corresponding raw images 302 may be used here.

FIG. 4 illustrates an example architecture 400 for a compressed domain for a number of different data formats for an AI model in accordance with this disclosure. For case of explanation, the architecture 400 of FIG. 4 is described as being used by the electronic device 101 in the network configuration 100 of FIG. 1. However, the architecture 400 may be used by any other suitable device(s) and in any other suitable system(s).

As shown in FIG. 4, similar to the architecture 300, the architecture 400 utilizes a trained teacher encoder 403 and a trained output decoder 405 to jointly define a compressed latent manifold 404 using an input teacher image 401. Latent variables in the compressed latent manifold 404 are derived by the teacher encoding and output decoding. The latent variables are refined based on generation of an output image 406 based on the latent variables and assessment of differences between the input teacher image 401 and the output image 406.

Transfer learning 407 is employed to train a raw data encoder 408 that operates on a raw data image 402. In some cases, the raw data encoder 408 may include multiple encoders for multiple data formats, such as a Bayer format image encoder 410 and a Tetra format image encoder 411. The latent manifold 404 defines a compressed domain that is shared by the various data formats involved, such as RGB, Bayer, and Tetra in the example shown. In this way, downstream ISP tasks can be performed in the same space without extra data conversion. Further, demosaicing of raw images is inherently performed by compressing the raw images onto the latent manifold 404 and decoding with the output decoder 405. An AI model 412 operates in the compressed domain of the latent manifold 404 and can be used to perform one or more ISP-related functions.

Although FIG. 4 illustrates one example of an architecture 400 for a compressed domain for a number of different data formats for an AI model, various changes may be made to FIG. 4. For example, any suitable number of images 401 and raw images 402 may be used here. Also, the specific image domains shown here are examples only.

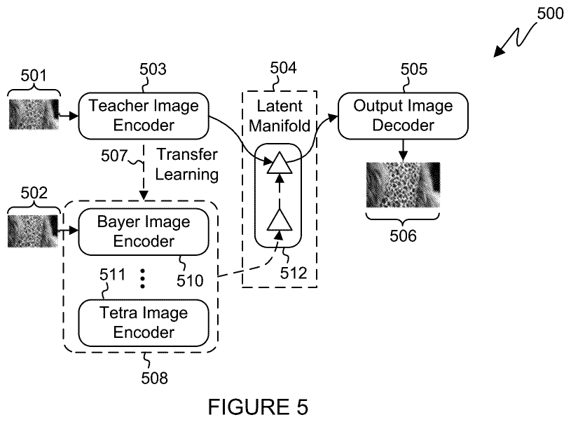

FIG. 5 illustrates an example architecture 500 for operation of an AI model within a compressed domain in accordance with this disclosure. For case of explanation, the architecture 500 of FIG. 5 is described as being used by the electronic device 101 in the network configuration 100 of FIG. 1. However, the architecture 500 may be used by any other suitable device(s) and in any other suitable system(s).

As shown in FIG. 5, similar to the architectures 300 and 400, the architecture 500 utilizes a trained teacher encoder 503 and a trained output decoder 505 to jointly define a compressed latent manifold 504 using an input teacher image 501. Latent variables in the compressed latent manifold 504 are derived by the teacher encoding and output decoding. The latent variables are refined based on generation of an output image 506 based on the latent variables and assessment of differences between the input teacher image 501 and the output image 506.

Transfer learning 507 is employed to train a raw data encoder 508 that operates on a raw data image 502. In some cases, the raw data encoder 508 may include multiple encoders for multiple data formats, such as a Bayer format image encoder 510 and a Tetra format image encoder 511. The latent manifold 504 defines a compressed domain that is shared by the various data formats involved, such as RGB, Bayer, and Tetra in the example shown. An AI model 512 operates in the compressed domain of the latent manifold 504 and can be used to perform one or more ISP-related functions.

In embodiments involving compressed domain denoising, a raw image 502 is denoised directly in the compressed latent space of the latent manifold 504 by designing a network for the AI model 512 that operates on the latent space to perform denoising. In embodiments involving compressed domain image sharpening, a raw image 502 is sharpened directly in the compressed latent space of the latent manifold 504 by designing a network for the AI model 512 that operates on the latent space to perform image sharpening. In embodiments involving compressed domain image sharpening, a raw image 502 is sharpened directly in the compressed latent space of the latent manifold 504 by designing a network for the AI model 512 that operates on the latent space to perform PSF inversion. In embodiments involving compressed domain image segmentation, a raw image 502 is segmented directly in the compressed latent space of the latent manifold 504 by designing a network for the AI model 512 that operates on the latent space to perform segmentation. In embodiments involving compressed domain motion map estimation, a raw image 502 within a sequence of raw images is processed directly in the compressed latent space of the latent manifold 504 by designing a network for the AI model 512 that operates on the latent space to perform motion map estimation for the sequence of raw images. In embodiments involving compressed domain motion image registration, a raw image 502 within a sequence of raw images is processed directly in the compressed latent space of the latent manifold 504 by designing a network for the AI model 512 that operates on the latent space to perform motion image registration for the sequence of raw images. Note that the same types of operations may occur using the AI model 412 of FIG. 4.

Although FIG. 5 illustrates one example of an architecture 500 for operation of an AI model within a compressed domain, various changes may be made to FIG. 5. For example, any suitable number of images 501 and raw images 502 may be used here. Also, the specific image domains shown here are examples only.

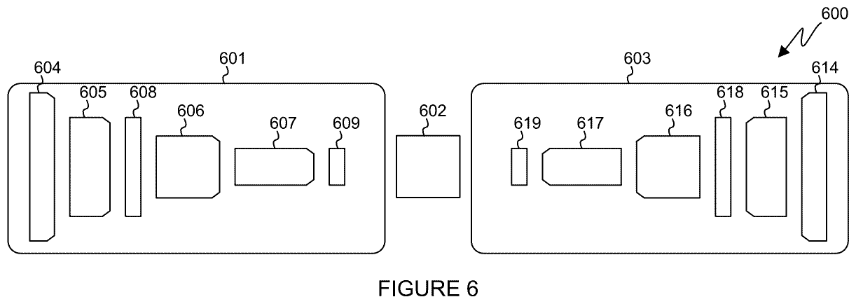

FIG. 6 illustrates an example AI model 600 for efficient raw domain compressed image data ISP in accordance with this disclosure. For case of explanation, the AI model 600 of FIG. 6 is described as being used by the electronic device 101 in the network configuration 100 of FIG. 1. However, the AI model 600 may be used by any other suitable device(s) and in any other suitable system(s).

As shown in FIG. 6, the model 600 includes an encoder 601, a quantization layer 602, and a decoder 603. In some embodiments, the encoder 601 includes a plurality of feed-forward convolutional neural network (CNN) layers 604-607, each of which can learn features via kernel optimization by applying a cascaded convolution (cross-correlation) kernel. In particular embodiments, the CNN layers 604-607 of the encoder 601 are of kernel size 5×5 and have a stride of two. Outputs of the CNN layer 605 and the CNN layer 607 are passed to local or sliding windowed attention layers 608 and 609, respectively, each of which uses a fixed window size. The model 600 is adapted for efficient compression of raw data by pruning and modifying blocks. Within the encoder 601, model pruning can be performed by removing one or more parameters in a manner substantially maintaining accuracy while reducing the model size and/or increasing efficiency.

The quantization layer 602 compresses the output of the encoder 601, such as by reducing the precision of weights (and optionally also bias and activation functions) so that the model requires less memory and may run on resource-constrained devices. The decoder 603 is essentially an inverse of the encoder 601 and includes a plurality of transposed CNN layers 614-617 and two windowed attention layers 618 and 619. In particular embodiments, the transposed CNN layers 614-617 of the decoder 603 are of kernel size 5×5 and have a stride of two.

Although FIG. 6 illustrates one example of an AI model 600 for efficient raw domain compressed image data ISP, various changes may be made to FIG. 6. For example, the AI model 600 may include any suitable number of layers in the encoder 601 and the decoder 603.

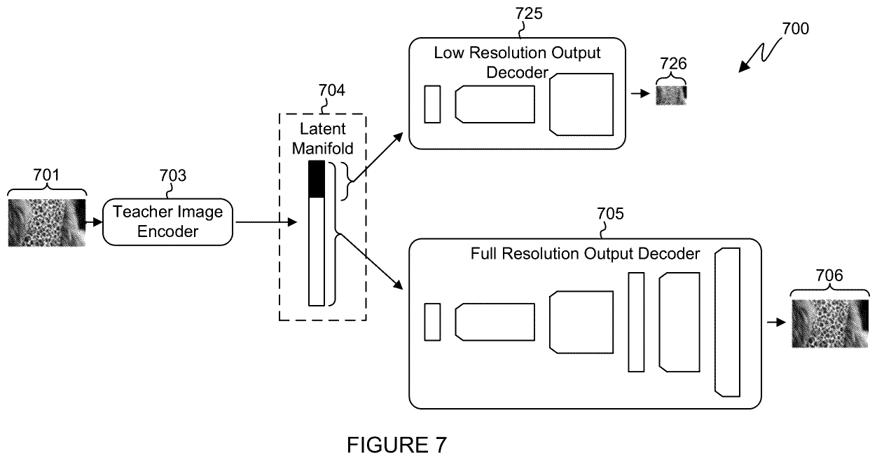

FIG. 7 illustrates an example architecture 700 for progressive compression-decompression for an AI model operating in the compressed domain in accordance with this disclosure. For ease of explanation, the architecture 700 of FIG. 7 is described as being used by the electronic device 101 in the network configuration 100 of FIG. 1. However, the architecture 700 may be used by any other suitable device(s) and in any other suitable system(s).

As shown in FIG. 7, similar to the architectures of FIGS. 3, 4, and 5, the architecture 700 of FIG. 7 utilizes a trained teacher data encoder 703 and a trained full-resolution output data decoder 705 to jointly define a compressed latent manifold 704 using an input teacher image 701. However, the architecture 700 also utilizes a trained low-resolution output data decoder 725 in defining the compressed latent manifold 704. The inclusion of the low-resolution output data decoder 725 allows generation of an output image 726 with lower resolution (such as a “preview” image) than the teacher image 706 generated by the full-resolution output data decoder 705. In some cases, this can be accomplished using only a proportion of the latent variables in the latent manifold 704. Downstream ISP tasks that do not require full-resolution image processing can therefore benefit from this approach. For example, motion map estimation or tone mapping analysis may save computations and memory usage with the progressive compression-decompression of FIG. 7.

Although FIG. 7 illustrates one example of an architecture 700 for progressive compression-decompression for an AI model operating in the compressed domain, various changes may be made to FIG. 7. For example, any suitable number of images 701 and raw images 702 may be used here.

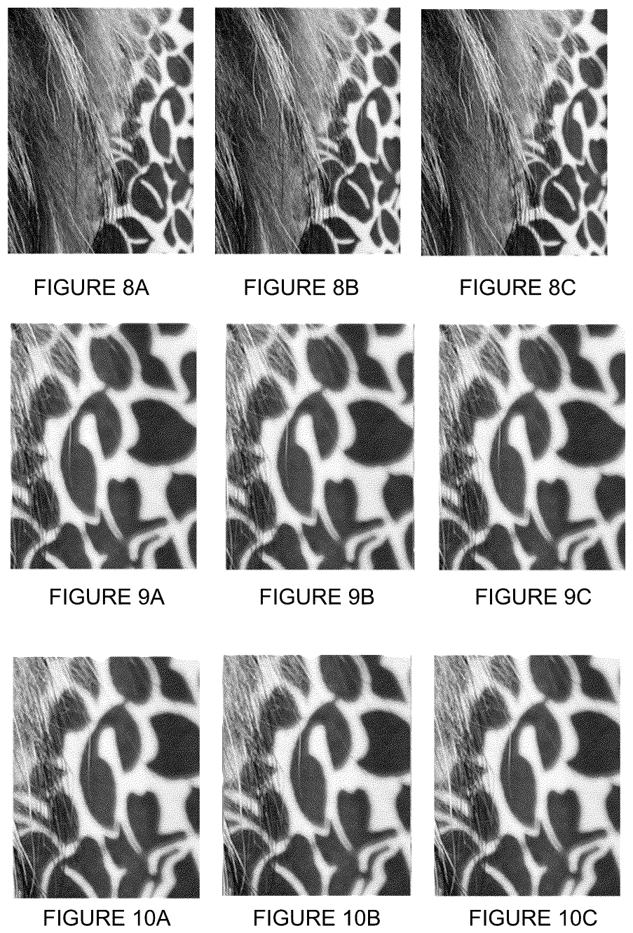

FIGS. 8A through 8C comparatively illustrate example compression and inherent demosaicing for raw data when using a compressed domain AI for image signal processing in accordance with this disclosure. More specifically, FIG. 8A illustrates raw (Tetra) image data input to a raw data encoder and corresponding image data output from an output data decoder. By comparison, FIG. 8B illustrates teacher image data input to an teacher data encoder and corresponding image data output from an output data decoder. FIG. 8C illustrates ground truth image data.

FIGS. 9A through 9C comparatively illustrate example compression and inherent demosaicing for raw data when using a compressed domain AI for image signal processing using an enlargement of a portion of the image content from FIGS. 8A through 8C in accordance with this disclosure. More specifically, FIG. 9A illustrates the output for raw (such as Tetra) image data input to a raw data encoder without a teacher model and transfer learning from a trained teacher data encoder and corresponding trained output data decoder for image data output. By comparison, FIG. 9B illustrates the output for the same raw image data input to a raw data encoder with a teacher model and transfer learning. FIG. 9C illustrates ground truth image data.

FIGS. 10A through 10C comparatively illustrate example raw image denoising in the compressed latent domain for image signal processing in accordance with this disclosure. More specifically, FIG. 10A illustrates the output for raw image data compression, compressed domain denoising, and decompression of noisy raw (Tetra) image raw data. By comparison, FIG. 10B illustrates the output for the raw image data compression and decompression of the same noisy raw image raw data without compressed domain denoising. FIG. 10C illustrates ground truth image data. FIG. 10A shows the result of raw image denoising in the compressed latent domain, where noisy latent variables are input into a denoising module, which in turn outputs clean latent variables.

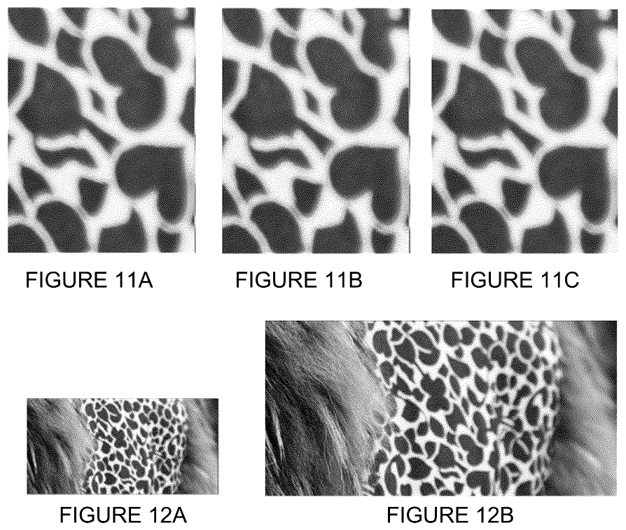

FIGS. 11A through 11C comparatively illustrate example multi-frame blending in the compressed domain for image signal processing in accordance with this disclosure. More specifically, FIG. 11A illustrates multi-frame blending in the compressed domain. By comparison, FIG. 11B illustrates a single frame in the compressed domain. FIG. 11C illustrates ground truth image data.

FIGS. 12A and 12B illustrate example results of progressive encoding and decoding in accordance with this disclosure. More specifically, FIG. 12B is the full resolution output, while FIG. 12A is a quarter resolution output from one-quarter of the most significant latent space variables within a latent manifold.

Although FIGS. 8A through 12B illustrate example results of various image processing operations, various changes may be made to FIGS. 8A through 12B. For example, the actual contents of images being processed can vary widely. Also, the specific results that are obtained can vary depending on the implementation.

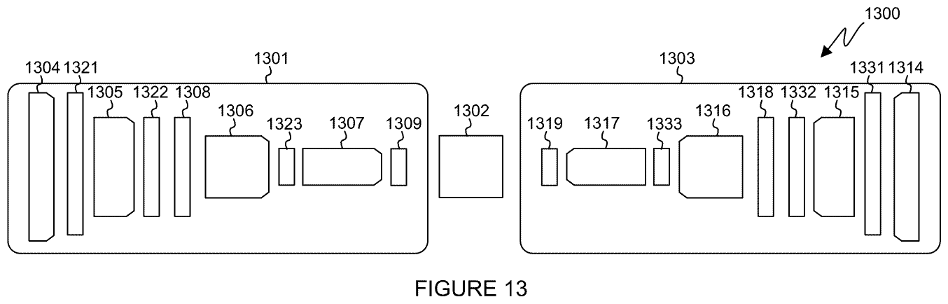

FIG. 13 illustrates another example AI model 1300 for efficient raw domain compressed image data ISP in accordance with this disclosure. For case of explanation, the AI model 1300 of FIG. 13 is described as being used by the electronic device 101 in the network configuration 100 of FIG. 1. However, the AI model 1300 may be used by any other suitable device(s) and in any other suitable system(s).

As shown in FIG. 13, the model 1300 is similar to the model 600 of FIG. 6. As with the model 600, the model 1300 includes an encoder 1301, a quantization layer 1302, and a decoder 1303. The encoder 1301 includes CNN layers 1304-1307 that correspond to the CNN layers 604-607 and windowed attention layers 1308-1309 that correspond to the windowed attention layers 608-609. The quantization layer 1302 is analogous to the quantization layer 602. The decoder 1303 includes transposed CNN layers 1314-1317 that correspond to the transposed CNN layers 614-617 and windowed attention layers 1318-1319 that correspond to the windowed attention layers 608-609.

The decoder 1303 in FIG. 13 also includes a generalized divisive normalization (GDN) layer 1321 between the CNN layer 1304 and the CNN layer 1305, a GDN layer 1322 between the CNN layer 1305 and the windowed attention layer 1308, and a GDN layer 1323 between the CNN layer 1306 and the CNN layer 1307. Each of the GDN layers 1321-1323 introduces a nonlinearity that improves the efficiency of the transforms by using reparameterization. The decoder 1303 includes an inverse GDN layer 1331 between the transposed CNN layer 1314 and the transposed CNN layer 1315, an inverse GDN layer 1332 between the transposed CNN layer 1315 and the windowed attention layer 1318, and an inverse GDN layer 1333 between the transposed CNN layer 1316 and the transposed CNN layer 1317. Each of the inverse GDN layers 1331-1333 performs the opposite function of the GDN layer 1321-1323, respectively. The GDN layers 1321-1323 and the inverse GDN layers 1331-1333 improve the performance of the model 1300 relative to the model size.

Although FIG. 13 illustrates another example of an AI model 1300 for efficient raw domain compressed image data ISP, various changes may be made to FIG. 13. For example, the AI model 1300 may include any suitable number of layers in the encoder 1301 and the decoder 1303.

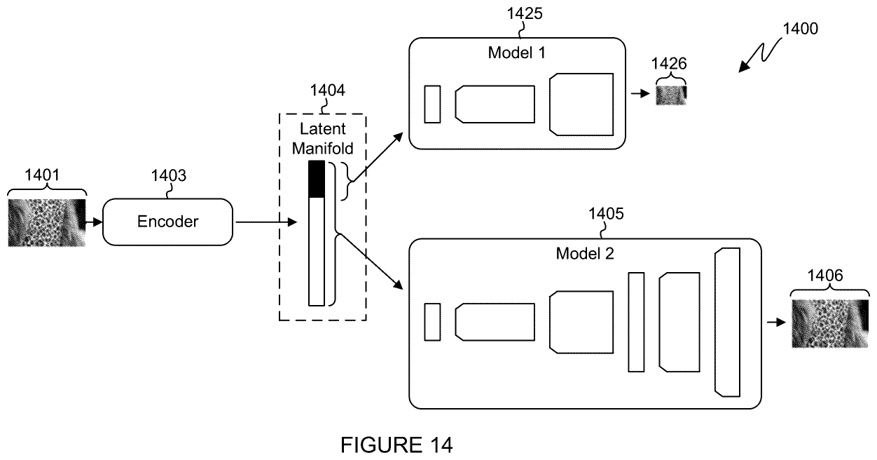

FIG. 14 illustrates an example architecture 1400 for generalized progressive compression-decompression for an AI model operating in the compressed domain in accordance with this disclosure. For case of explanation, the architecture 1400 of FIG. 14 is described as being used by the electronic device 101 in the network configuration 100 of FIG. 1. However, the architecture 1400 may be used by any other suitable device(s) and in any other suitable system(s).

As shown in FIG. 14, similar to the architecture 700 of FIG. 7, the architecture 1400 utilizes a trained data encoder 1403 in defining a compressed latent manifold 1404 based on an input image 1401. In addition, the architecture 1400 also utilizes a trained full-resolution data decoder 1405 and a trained low-resolution data decoder 1425. However, the full-resolution data decoder 1405 generating a full-resolution image 1406 and the low-resolution data decoder 1425 generating a low-resolution image 1426 need not be models for performing the same type of image analysis or image processing. In some cases, the image processing pipeline can include both pixel-level processing tasks, such as denoising and demosaicing, and global-level analysis tasks, such as tone-mapping gain estimation and motion estimation. Not all analysis tasks need full-resolution images.

With the progressive data encoder 1403, the most significant bits of the compressed data can be decoded into a low-resolution image 1426 using the lightweight low-resolution data decoder 1425, while a full-resolution image 1406 can be recovered using the full-resolution data decoder 1405. For analysis tasks such as registration, the most-significant bits of the compressed data may be used to save computation and memory. For other tasks, the full compressed data can be used. The low-resolution data decoder 1425 and the full-resolution data decoder 1405 may be different AI models (“Model 1” and “Model 2,” respectively) performing different image analysis or image processing tasks. For example, “Model 1” may perform a global-level processing task such as image registration, while “Model 2” performs a pixel-level processing task such as denoising.

Although FIG. 14 illustrates one example of an architecture 1400 for generalized progressive compression-decompression for an AI model operating in the compressed domain, various changes may be made to FIG. 14. For example, any suitable number of images 1401 may be used here.

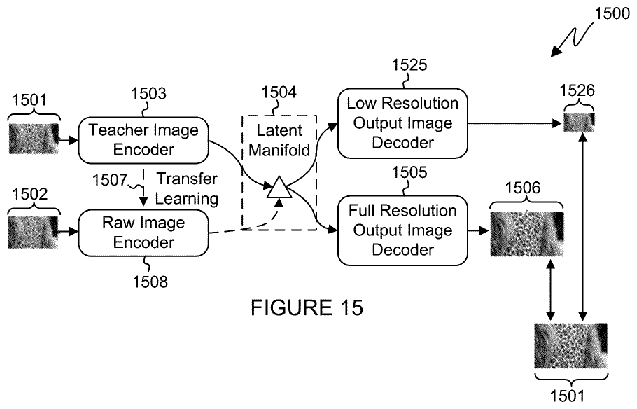

FIG. 15 illustrates an example architecture 1500 for derivation of a compressed domain for an AI model utilizing generalized progressive compression-decompression in accordance with this disclosure. For case of explanation, the architecture 1500 of FIG. 15 is described as being used by the electronic device 101 in the network configuration 100 of FIG. 1. However, the architecture 1500 may be used by any other suitable device(s) and in any other suitable system(s).

As shown in FIG. 15, similar to the architecture 300 of FIG. 3, the architecture 1500 utilizes a trained teacher encoder 1503 with a teacher image 1501 as an input and generates compressed latent variables for a latent manifold 1504. A trained full-resolution output decoder 1505 for generating a full-resolution output image 1506 based on the latent variables within the latent manifold 1504 is provided, together with a trained low-resolution output decoder 1525 for generating a low-resolution output image 1526. Differences between the original teacher image 1501 and both of the generated full-resolution output image 1506 and the generated low-resolution output image 1526 may be employed in refining the latent variables for the compressed latent manifold 1504. In some cases, the differences may encompass RGB reconstruction loss, GAN loss, and/or perceptual loss.

Via transfer learning 1507, the full-resolution raw image encoder 1508 is employed to augment the latent variables within the latent manifold 1504. This may help to account for latent distance loss. The latent manifold 1504 may be employed based on a raw data image 1502, such as by different AI models performing different image analysis or image processing tasks.

Although FIG. 15 illustrates one example of an architecture 1500 for derivation of a compressed domain for an AI model utilizing generalized progressive compression-decompression, various changes may be made to FIG. 15. For example, any suitable number of images 1501 and corresponding raw images 1502 may be used here.

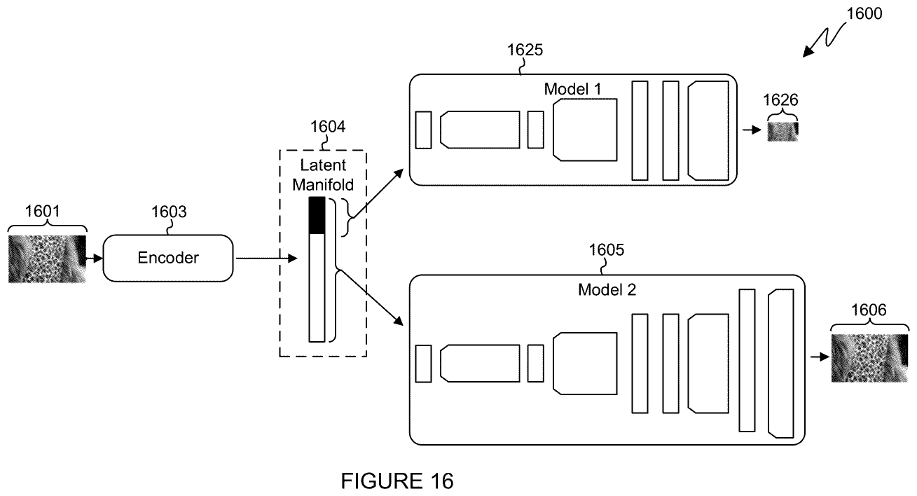

FIG. 16 illustrates an example architecture 1600 for generalized progressive compression-decompression for an AI model in accordance with this disclosure. For case of explanation, the architecture 1600 of FIG. 16 is described as being used by the electronic device 101 in the network configuration 100 of FIG. 1. However, the architecture 1600 may be used by any other suitable device(s) and in any other suitable system(s).

As shown in FIG. 16, similar to the architecture 1400 of FIG. 14, the architecture 1600 utilizes a trained data encoder 1603 in defining a compressed latent manifold 1604 based on an input image 1601. Although not explicitly shown, the data encoder 1603 may use the same layers as the encoder 1301 in FIG. 13, including GDN layers. The architecture 1600 also utilizes a trained full-resolution data decoder 1605 for generating a full-resolution image 1606 and a trained low-resolution data decoder 1625 for generating a low-resolution image 1626. Both the full-resolution data decoder 1605 and the low-resolution data decoder 1625 may include inverse GDN layers. In the example shown, the full-resolution data decoder 1605 may use the same layers as the decoder 1303 in FIG. 13, while the low-resolution data decoder 1625 may use one less transposed CNN layer and one less inverse GDN layer than the full-resolution data decoder 1605.

Although FIG. 16 illustrates one example of an architecture 1600 for generalized progressive compression-decompression for an AI model, various changes may be made to FIG. 16. For example, any suitable number of images 1601 may be used here.

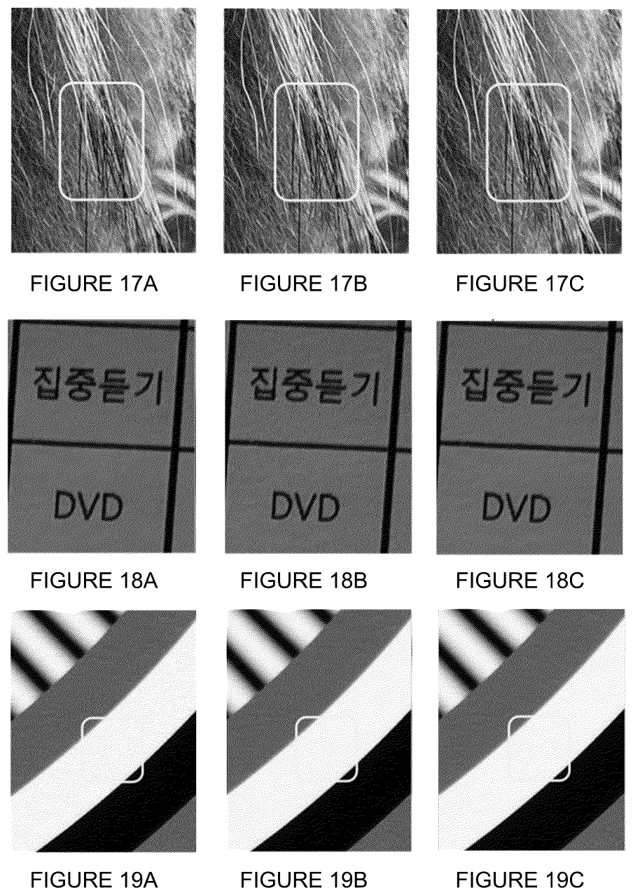

FIGS. 17A through 17C comparatively illustrate example compression and inherent demosaicing for raw data when using a low-resolution decoder for a compressed domain AI performing image signal processing in accordance with this disclosure. More specifically, FIG. 17A illustrates low-resolution output for raw (Tetra) image data input to a full-resolution raw data encoder without a teacher model and transfer learning from a trained RGB data encoder and corresponding trained RGB data decoder for RGB image data output. By comparison, FIG. 17B illustrates the low-resolution output for the same raw image data input to a raw data encoder with a teacher model and transfer learning. FIG. 17C illustrates ground truth image data. The compression ratio for low-resolution image processing in the example shown is five.

FIGS. 18A through 18C comparatively illustrate example raw image denoising using a low-resolution decoder for a compressed domain AI performing image signal processing in accordance with this disclosure. More specifically, FIG. 18A illustrates the output for raw image data compression, compressed domain denoising, and low-resolution decompression of noisy raw (Tetra) image raw data. By comparison, FIG. 18B illustrates the output for the raw image data compression and low-resolution decompression of the same noisy raw image raw data without compressed domain denoising. FIG. 18C illustrates ground truth image data. Again, the compression ratio for low-resolution image processing in the example shown is five.

FIGS. 19A through 19C comparatively illustrate example multi-frame blending using a low-resolution decoder for a compressed domain AI performing image signal processing in accordance with this disclosure. More specifically, FIG. 19B illustrates multi-frame blending in the compressed domain. By comparison, FIG. 19A illustrates a single frame in the compressed domain. FIG. 19C illustrates ground truth image data. Again, the compression ratio for low-resolution image processing in the example shown is five. The compressed domain multi-frame blending effectively reduces noise while maintaining details.

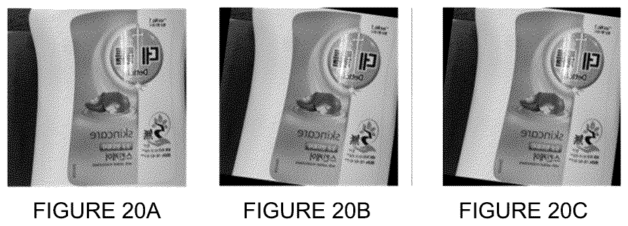

FIGS. 20A through 20C comparatively illustrate example image registration using a low-resolution decoder for a compressed domain AI performing image signal processing in accordance with this disclosure. More specifically, FIG. 20A illustrates the original image, FIG. 20B illustrates the warped image, and FIG. 20C illustrates the target image. The warped image of FIG. 20B closely matches the target of FIG. 20C, indicating that compressed domain registration parameter estimation is accurate. Again, the compression ratio for low-resolution image processing in the example shown is five.

Although FIGS. 17A through 20C illustrate example results of various image processing operations, various changes may be made to FIGS. 17A through 20C. For example, the actual contents of images being processed can vary widely. Also, the specific results that are obtained can vary depending on the implementation.

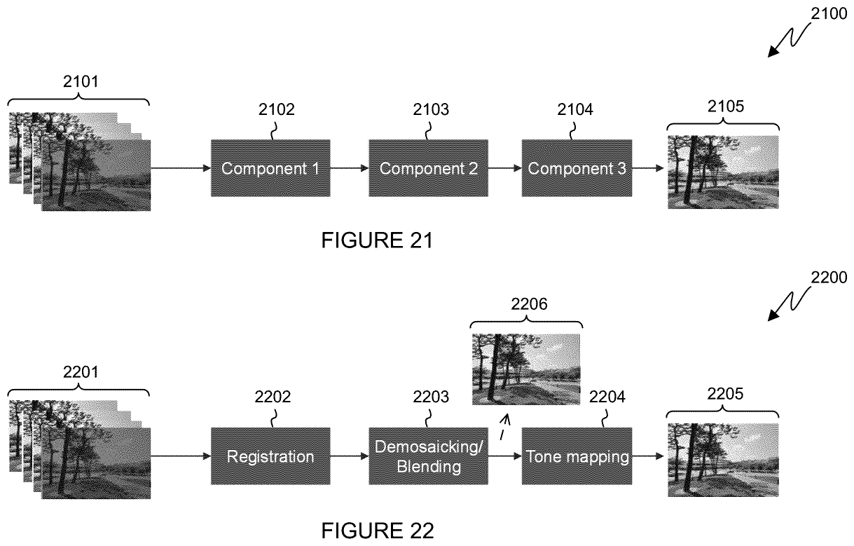

FIG. 21 illustrates a typical multi-frame ISP pipeline 2100. In this example, the pipeline 2100 operates on multiple images 2101 and includes a sequence of various components 2102-2104 that successively operate on image data to produce an output image 2105. Any of the ISP tasks performed by the components 2102-2104 may be performed using AI-based implementations.

FIG. 22 illustrates a specific example of a multi-frame ISP pipeline 2200. Here, the pipeline 2200 operates on multiple images 2201. An image registration component 2202 aligns the multiple images 2201. A demosaicing and blending component 2203 estimates a color image that most closely resembles the original image represented by the multiple images 2201 and blends information from the multiple images 2201 together to form a single image 2206. A tone mapping component 2204 maps colors in the single image 2206 to another set of colors to approximate the appearance of a high dynamic range (HDR) image, which corresponds to an output image 2205.

There is an increasing need for high-megapixel imaging systems (such as 50 megapixels and up) using multi-frame imaging pipelines of the type depicted in FIGS. 21 and 22. These pipelines can be used for imaging to achieve noise-reduction and HDR, especially in light of the following problems. First, memory and computing constraints can limit the number of images that can be used for high-megapixel pipelines. Second, conventional compression methods are not directly designed for compressed domain ISP downstream tasks, such as demosaicing and/or denoising. Reducing the memory footprint of high-megapixel pipelines with conventional compression often necessitates repeatedly de-compressing, processing, and compressing data, resulting in high compute/memory overhead. Third, the compression ratio for conventional compression methods is typically image content-dependent. As a result, reducing the memory footprint of high-megapixel pipelines with conventional compression becomes challenging.

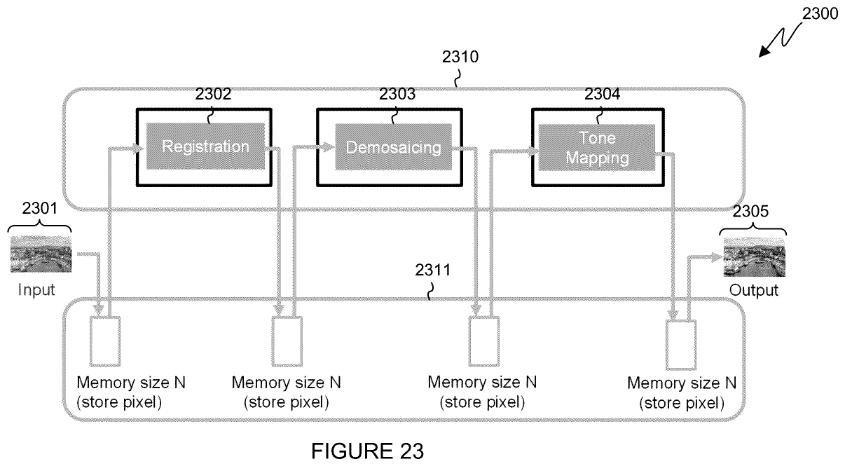

FIG. 23 illustrates a pipeline 2300 for the ISP sequence of FIG. 22 in the context of a compute engine 2310 and memory 2311. In the pipeline 2300, images 2301 are loaded into a memory 2311, read from the memory 2311 for processing, processed by the compute engine 2310, and written to the memory 2311 again for subsequent processing. In the example of FIG. 23, the pipeline 2300 requires an initial memory write, three memory read-write pairs (one each for the image registration component 2302, the demosaicing and blending component 2303, and the tone mapping component 2304), and a final memory read for the output image 2305. The memory read and write requirements limit the size (N) of the images and the number of the images that can be used in the pipeline 2300. High-resolution cameras exacerbate the problem.

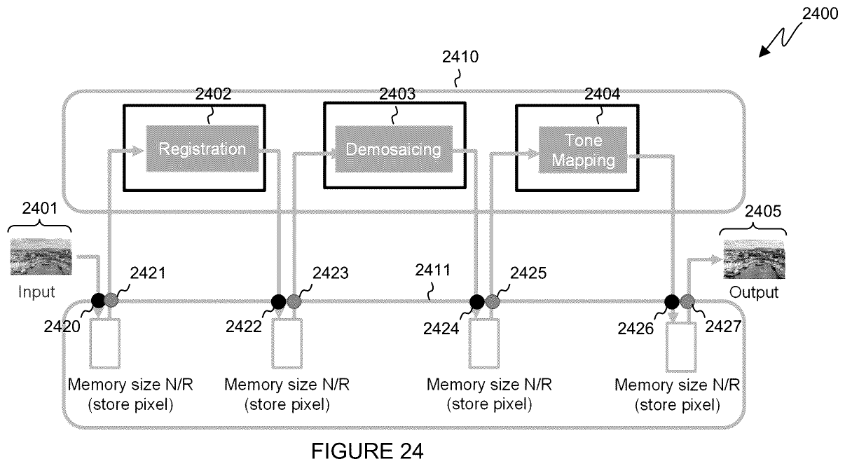

FIG. 24 illustrates a pipeline 2400 for the ISP sequence of FIG. 22 in the context of a compute engine 2410 and memory 2411 and assuming a specified data compression ratio. Memory compression using conventional compression methods can be used to reduce memory consumption. However, ISP downstream tasks (such as demosaicing and/or denoising) are typically not designed to operate with such compressed data. Therefore, in the pipeline 2400, images 2401 are loaded into a memory 2411 and processed by the image registration component 2402, the demosaicing and blending component 2403, and the tone mapping component 2404 to produce an output image 2405. The images 2401 are subject to compression 2420 when initially written to the memory 2411. Performing the ISP downstream tasks (image registration, demosaicing and blending, and tone mapping) typically requires decompression 2421, 2423, and 2425 of the images 2401 to full size, performance of the corresponding full-size image processing, compression 2422, 2424, and 2426 of the output from each of the image registration component 2402, the demosaicing and blending component 2403, and the tone mapping component 2404 when the processed full-size data is written to memory, and decompression 2427 of the output image 2405. Repeated decompression, processing, and compression steps generally result in high compute/memory overhead.

Furthermore, memory compression using conventional compression techniques are designed for standardized color space images rather than raw format images, particularly those with certain color filter array (CFA) patterns such as Bayer, Tetra, etc. Raw data processing may be useful or important in modern ISPs, such as for 50 megapixel cameras equipped with CFAs. Applying such conventional compression techniques to raw data results in loss of detail and the creation of other image artifacts.

With increasing resolution, memory requirements for multi-frame imaging pipelines become a bottleneck for downstream tasks of such pipelines. That problem can persist even with AI-based implementations of downstream tasks of the multi-frame imaging pipelines. The approach to address these issues described above is to compress high-resolution images to a compressed domain with smaller size and perform the downstream tasks, such as demosaicing and denoising, in the compressed domain. As noted above, designing such an effective and general compression domain for downstream tasks remains challenging.

A compression technique that is well-suited for all image formats (such as both RGB and raw) may compress high-resolution images to a compressed domain (referred to here as a latent space or latent manifold) where the images can be represented with a reduced set of features (referred to here as latent variables), resulting in a smaller-size representation. An AI-based encoder that compresses high-resolution images from an image space to a compressed domain can be employed, together with a novel AI-based decoder that decompresses images from the compressed domain to the image space. AI-based ISP pipeline tasks that are suited for the compressed domain can also be employed, providing a way to perform one, some, or all of the downstream ISP pipeline tasks in the compressed domain. As a result, a system can be suited for the compressed domain, can be compatible with one or more downstream ISP tasks (even for high-megapixel pipelines), and can reduce or minimize image losses and artifacts. Further, use cases can be enabled that are not currently possible due to a lack of memory.

In this disclosure, a pipeline can utilize AI to compress data and perform AI-based processing on compressed data. For AI-based compression and processing according to this disclosure, the pipeline can use AI encoder networks to compress images to an encoded space that has a smaller size than the original image(s), thereby providing memory savings. AI-based processing can be performed on the compressed image(s) to output one or more processed compressed domain images. AI decoder networks can be used to decode the compressed image(s) into one or more uncompressed images. For multi-frame images, the pipeline can utilize AI to compress the multi-frame images and perform AI-based processing on the compressed images. For multi-task processing, the pipeline can utilize AI to compress sensor data and perform AI-based processing on the compressed sensor data to complete various downstream tasks.

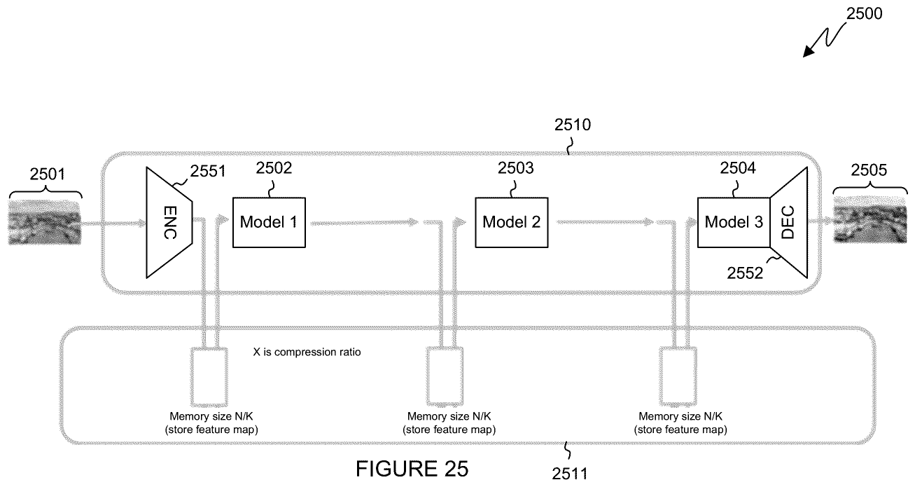

FIG. 25 illustrates an example pipeline 2500 utilizing AI to compress data and performing AI-based processing on the compressed data in accordance with this disclosure. For case of explanation, the pipeline 2500 of FIG. 25 is described as being used by the electronic device 101 in the network configuration 100 of FIG. 1. However, the pipeline 2500 may be used by any other suitable device(s) and in any other suitable system(s).

As shown in FIG. 25, the pipeline 2500 uses AI encoder networks to compress images 2501 to an encoded space so that each encoded image has a smaller size than the corresponding original image, thereby providing memory savings. AI-based processing is used on the compressed images to output processed compressed domain images, and AI decoder networks are used to decode the compressed images into uncompressed images 2505. In the context of a compute engine 2510 and memory 2511, the pipeline 2500 includes a first model 2502 (“Model 1,” such as an image registration component), a second model 2503 (“Model 2,” such as a demosaicing and blending component), and a third model 2504 (“Model 3,” such as a tone mapping component). An AI encoder 2551 executes on the compute engine 2510, writing compressed domain image data (the latent variables for a latent manifold) to the memory 2511. The first model 2502, the second model 2503, and a third model 2504 operate on the compressed domain image data. An AI decoder 2552 executes on the compute engine 2510, reading processed compressed domain image data from the memory 2511 and decoding for output as the uncompressed images 2505.

Within the pipeline 2500, if a downstream task uses pixel-wise operations (such as for a denoising operation), a decoder could handle that operation. However, if the downstream task uses global operations (such as for a registration operation), a compressed domain model could handle the operation. The pipeline 2500 can process multi-frame data and, for multi-task operations, can perform multiple downstream image processing tasks using AI-based processing on the compressed domain image data.

Although FIG. 25 illustrates one example of a pipeline 2500 utilizing AI to compress data and performing AI-based processing on the compressed data, various changes may be made to FIG. 25. For example, while three models are shown here, the pipeline 2500 may support the use of any suitable number of models.

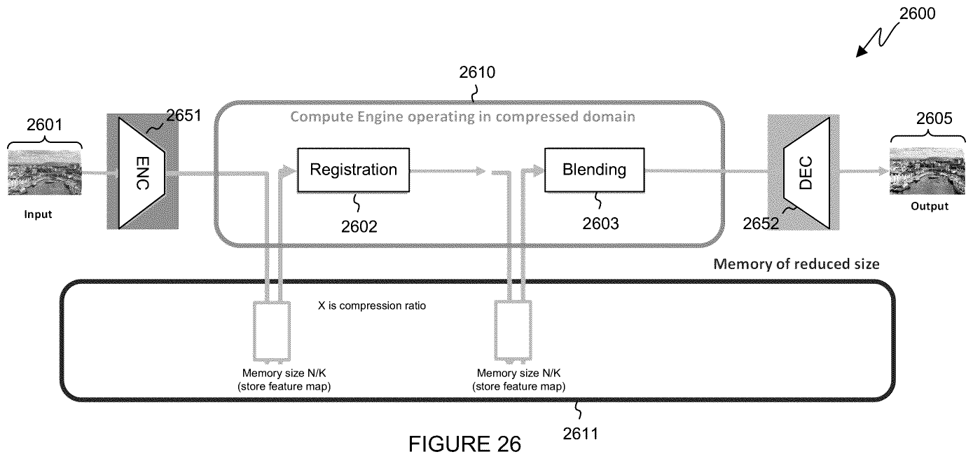

FIG. 26 illustrates another example pipeline 2600 utilizing AI to compress data and performing AI-based processing on the compressed data in accordance with this disclosure. For case of explanation, the pipeline 2600 of FIG. 26 is described as being used by the electronic device 101 in the network configuration 100 of FIG. 1. However, the pipeline 2600 may be used by any other suitable device(s) and in any other suitable system(s).

As shown in FIG. 26, similar to the pipeline 2500 of FIG. 25, the pipeline 2600 uses AI encoder networks 2651 to compress images 2601 and AI decoder networks 2652 to decode compressed images into uncompressed images 2605. However, the AI encoder networks 2651 and the AI decoder networks 2652 need not execute on the same compute engine 2610 as the AI model(s) processing the compressed domain image data. Instead, as shown in FIG. 26, the AI encoder networks 2651 may execute separately from the compute engine 2610 and pass the compressed domain image data to the compute engine 2610. The compute engine 2610 stores the received compressed domain image data in memory 2611. The compute engine 2610 also retrieves portions of the stored compressed domain data as needed or desired for processing by a first model 2602 (such as an image registration component) and a second model 2603 (such as a blending component). Processed compressed domain image data is passed to the AI decoder networks 2652 for output.

AI-based data compression and AI-based processing on the compressed data may exploit progressive compression and processing. With progressive compression and processing, the pipeline 2600 can utilize the AI encoder networks 2651 to perform progressive AI compression (such as when the compressed data is ordered from most significant bits to least significant bits), and AI-based processing may be performed (such as by the first model 2602 performing image registration) on only the most significant bits of the compressed data to efficiently perform downstream analysis tasks that do not need full-resolution data. With progressive AI compression, the most-significant bits of the compressed data can be used to get low-resolution images that can be used for performing tasks on the compressed domain image data that do not require full-resolution data, such as registration, tone-map gain computation, etc.

Although FIG. 26 illustrates another example of a pipeline 2600 utilizing AI to compress data and performing AI-based processing on the compressed data, various changes may be made to FIG. 26. For example, while two models are shown here, the pipeline 2600 may support the use of any suitable number of models.

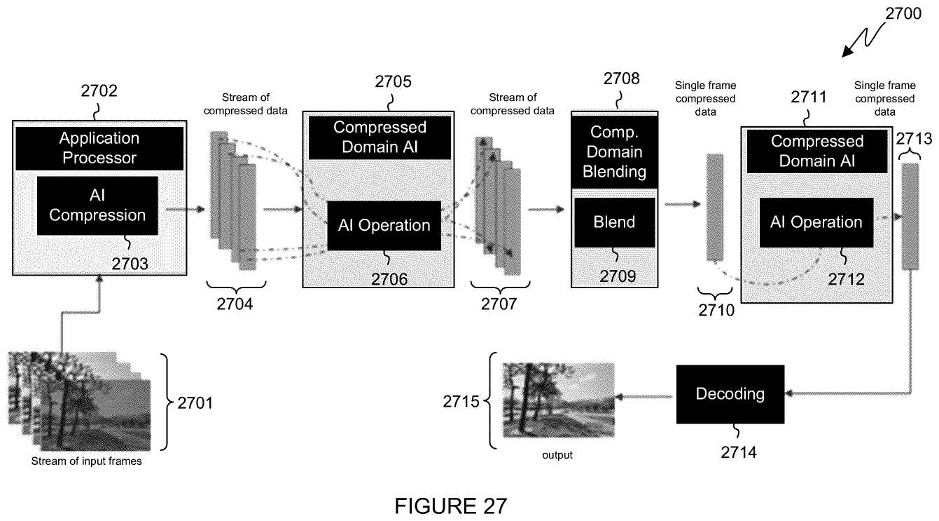

FIG. 27 illustrates an example compressed domain AI multi-frame multi-task pipeline 2700 in accordance with this disclosure. For case of explanation, the pipeline 2700 of FIG. 27 is described as being used by the electronic device 101 in the network configuration 100 of FIG. 1. However, the pipeline 2700 may be used by any other suitable device(s) and in any other suitable system(s).

As shown in FIG. 27, a stream of input frames 2701 is received by an application processor 2702 that performs AI compression 2703 on the input frames 2701 and outputs a stream of compressed data 2704. A first compressed domain AI model 2705 receives the compressed data 2704 and performs an AI operation 2706 (such as image registration), outputting a processed stream of compressed data 2707. A compressed domain image processor 2708 performs an image processing function (such as blending 2709) on the stream of processed stream of compressed data 2707. The compressed domain image processor 2708 outputs a single frame of compressed data 2710. A second compressed domain AI model 2711 receives the compressed data 2710 and performs an AI operation 2712, outputting a processed single frame of compressed data 2713. The processed single frame of compressed data 2713 undergoes AI decoding 2714 to produce an output image 2715.

Although FIG. 27 illustrates one example of a compressed domain AI multi-frame multi-task pipeline 2700, various changes may be made to FIG. 27. For example, while three compressed domain operations are shown here, the pipeline 2700 may support the use of any suitable number of compressed domain operations. Also, any other or additional compressed domain operations may be performed here.

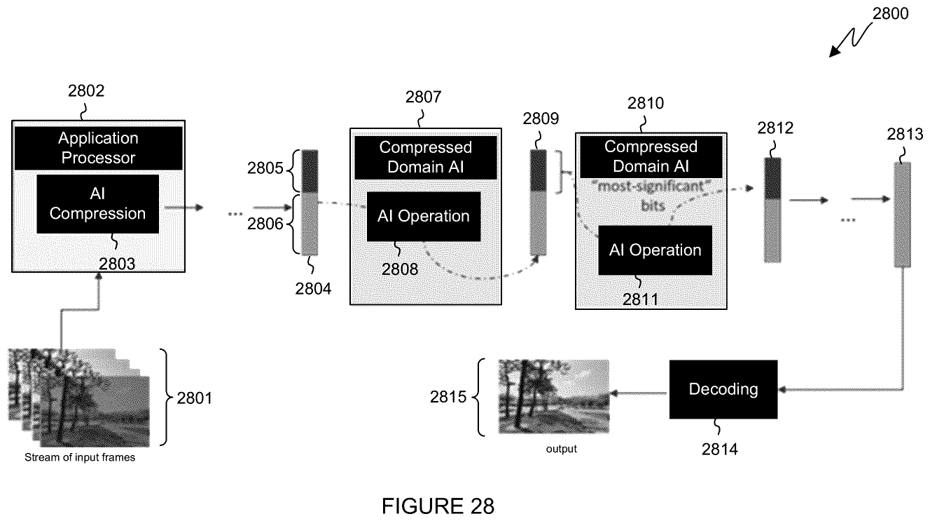

FIG. 28 illustrates an example pipeline 2800 utilizing progressive AI compression and using most significant bits to efficiently perform downstream tasks that do not need full-resolution data in accordance with this disclosure. For case of explanation, the pipeline 2800 of FIG. 28 is described as being used by the electronic device 101 in the network configuration 100 of FIG. 1. However, the pipeline 2800 may be used by any other suitable device(s) and in any other suitable system(s).

As shown in FIG. 28, similar to the pipeline 2700 of FIG. 27, the pipeline 2800 receives a stream of input frames 2801 at an application processor 2802 that performs AI compression 2803 on those input frames 2801 and outputs a stream of compressed data 2804. The AI compression 2803 is progressive (such as when the compressed data is ordered from most significant bits 2805 to least significant bits 2806). A first compressed domain AI model 2807 receives the compressed data 2804 and performs an AI operation 2808 that operates on all of the compressed data 2804, outputting a processed stream of compressed data 2809. A second compressed domain AI model 2810 receives the compressed data 2809 and performs an AI operation 2811 that operates on only the most significant bits of the compressed data 2809, efficiently performing an analysis task that does not need full-resolution data. The second compressed domain AI model 2810 outputs all of the compressed data 2812 but possibly with only the most significant bits modified. Additional processing on the compressed data 2812 may be performed within the pipeline 2800, producing compressed data 2813 that undergoes AI decoding 2814 to produce an RGB output image 2815.

In a typical pipeline, there are analysis steps (such as registration) that do not require full-resolution images. For these cases, operating on the full compressed data is unnecessary and computationally expensive. Instead, with a progressive encoder (such as AI compression 2803 performed by the application processor 2802 in the pipeline 2800), the most significant bits of the compressed data can be decoded into a low-resolution image using a separate lightweight low-resolution decoder (not shown), while the full-resolution image can be recovered using the full decoder (such as AI decoding 2814). For analysis tasks such as registration, only the most-significant bits of the compressed data might be used. For other tasks, the full compressed data can be used.

Although FIG. 28 illustrates one example of a pipeline 2800 utilizing progressive AI compression and using most significant bits to efficiently perform downstream tasks that do not need full-resolution data, various changes may be made to FIG. 28. For example, while two compressed domain operations are shown here, the pipeline 2800 may support the use of any suitable number of compressed domain operations. Also, any other or additional compressed domain operations may be performed here.

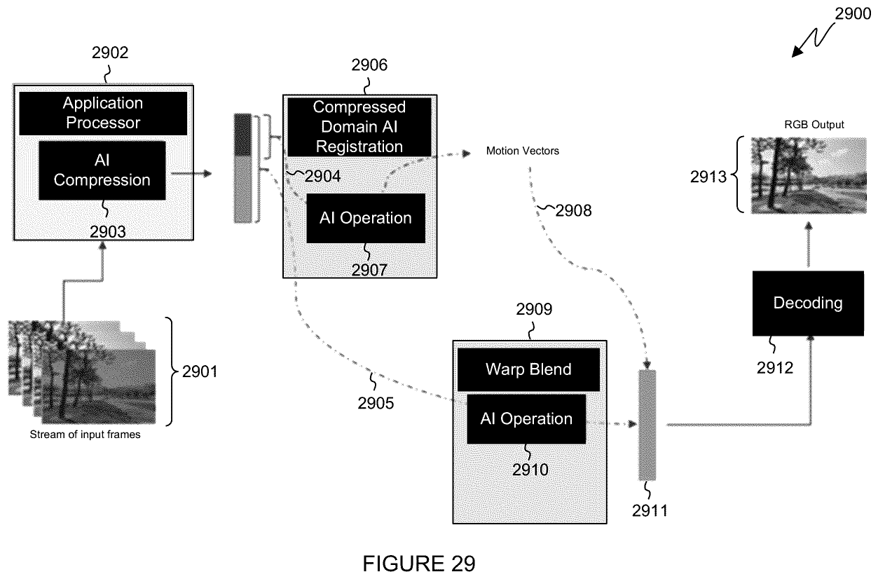

FIG. 29 illustrates another example pipeline 2900 utilizing progressive AI compression and using most significant bits to efficiently perform downstream tasks that do not need full-resolution data in accordance with this disclosure. For case of explanation, the pipeline 2900 of FIG. 29 is described as being used by the electronic device 101 in the network configuration 100 of FIG. 1. However, the pipeline 2900 may be used by any other suitable device(s) and in any other suitable system(s).

As shown in FIG. 29, similar to the pipelines of FIGS. 27 and 28, the pipeline 2900 receives a stream of input frames 2901 at an application processor 2902 that performs AI compression 2903 on those input frames 2901 and outputs a stream of compressed data 2904. The AI compression 2903 is progressive (such as when the compressed data is ordered from most significant bits to least significant bits). Unlike the sequential AI operations 2808 and 2811 in the pipeline 2800, AI operations are performed in tandem in the pipeline 2900. In this example, the most significant bits 2904 of the compressed data 2905 are received by a first compressed domain AI model 2906 that performs an AI operation 2907 such as registration to obtain motion vectors 2908. The full set of the compressed data 2904 is received by a second compressed domain AI model 2909 that performs an AI operation 2910 such as a warp-blend operation. The outputs of the AI operation 2907 and the AI operation 2910 are combined to generate processed compressed data 2911, which undergoes AI decoding 2912 to produce an RGB output image 2913.

Although FIG. 29 illustrates another example of a pipeline 2900 utilizing progressive AI compression and using most significant bits to efficiently perform downstream tasks that do not need full-resolution data, various changes may be made to FIG. 29. For example, while two compressed domain operations are shown here, the pipeline 2900 may support the use of any suitable number of compressed domain operations. Also, any other or additional compressed domain operations may be performed here.

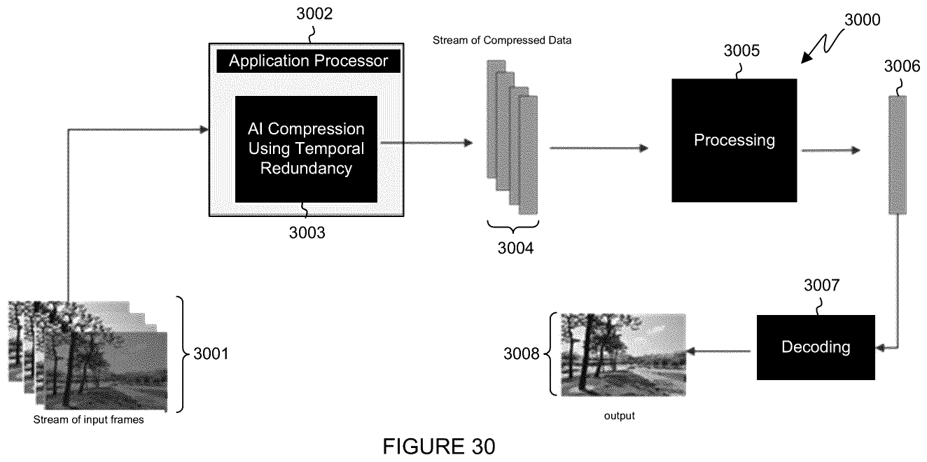

FIG. 30 illustrates an example pipeline 3000 utilizing AI to compress multi-frame data using temporal redundancy between frames in accordance with this disclosure. For case of explanation, the pipeline 3000 of FIG. 30 is described as being used by the electronic device 101 in the network configuration 100 of FIG. 1. However, the pipeline 3000 may be used by any other suitable device(s) and in any other suitable system(s).

In some cases, AI-based data compression and AI-based processing on the compressed data may exploit temporal redundancy during encoding. For example, with temporal redundancy-based encoding, the pipeline 3000 utilizes AI to compress multi-frame data 3001 by exploiting the temporal redundancy between the frames of the multi-frame data 3001 and performs AI-based processing on the compressed data. The example pipeline 3000 of FIG. 30 receives the stream of input frames for the multi-frame data 3001 at an application processor 3002 that performs AI compression 3003 using temporal redundancy between those input frames for the multi-frame data 3001. The application processor 3002 outputs a stream of compressed data 3004. The compressed data 3004 is subject to subsequent processing 3005 to generate a processed single frame of compressed data 3006, which undergoes AI decoding 3007 to produce an output image 3008.

Although FIG. 30 illustrates one example of a pipeline 3000 utilizing AI to compress multi-frame data using temporal redundancy between frames, various changes may be made to FIG. 30. For example, the processing 3005 here may include any suitable number and types of compressed domain operations.

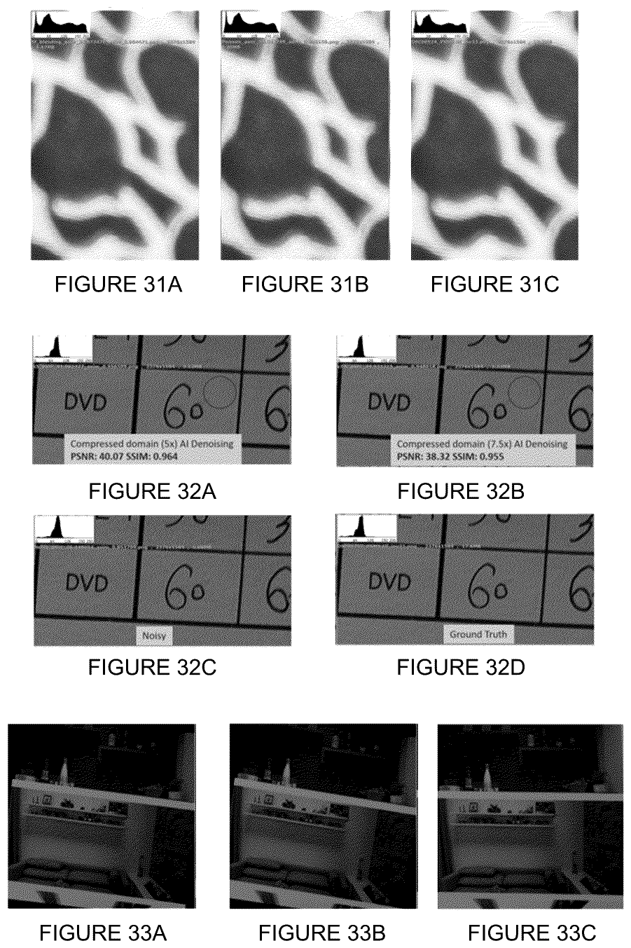

FIGS. 31A through 31C comparatively illustrate an example result of multi-frame blending in a compressed domain for AI-based image signal processing in accordance with this disclosure. More specifically, FIG. 31A illustrates the effect of multi-frame blending in the compressed domain in which noisy Tetra raw frames are compressed (such as using AI-based compression), multi-frame blending occurs in the compressed domain, and AI decoding to RGB is performed. By contrast, FIG. 31B illustrates the effect of AI-based compression of noisy Tetra raw frames followed by AI decoding to RGB without multi-frame blending in the compressed domain. FIG. 31C illustrates paired RGB ground truth obtained by a digital single lens reflex (DSLR) camera by shifting the sensor to collect all three channels at all pixel locations. A compression ratio of five, producing compressed data with five times smaller memory footprint that the raw Tetra input data, is employed with five frames.

FIGS. 32A through 32D comparatively illustrate an example result of compressed domain for AI denoising in accordance with this disclosure. More specifically, FIGS. 32A and 32B illustrates the effect of AI denoising in the compressed domain in which noisy Tetra raw frames are compressed (such as using AI-based compression), AI denoising occurs in the compressed domain, and AI decoding to RGB is performed. By contrast, FIG. 32C illustrates the effect of AI-based compression of noisy Tetra raw frames followed by AI decoding to RGB without AI denoising in the compressed domain. FIG. 32D illustrates paired RGB ground truth obtained by a DSLR camera by shifting the sensor to collect all three channels at all pixel locations. A compression ratio of five is employed in FIG. 32A, and a compression ratio of 7.5 is employed in FIG. 32D.

FIGS. 33A through 33C comparatively illustrate an example result of compressed domain for AI registration in accordance with this disclosure. More specifically, FIGS. 33A and 33C illustrate reference and input frames, respectively. FIG. 33B illustrates the effect of compressed domain AI registration in which noisy Tetra raw frames are compressed (such as using AI-based compression), AI occurs in the compressed domain, and AI decoding to RGB is performed. Warping is also performed via registration parameters obtained from AI registration.

Although FIGS. 30A through 33B illustrate example results of various image processing operations, various changes may be made to FIGS. 30A through 33B. For example, the actual contents of images being processed can vary widely. Also, the specific results that are obtained can vary depending on the implementation.

It should be noted that the functions shown in the figures or described above can be implemented in an electronic device 101, 102, 104, server 106, or other device(s) in any suitable manner. For example, in some embodiments, at least some of the functions shown in the figures or described above can be implemented or supported using one or more software applications or other software instructions that are executed by the processor 120 of the electronic device 101, 102, 104, server 106, or other device(s). In other embodiments, at least some of the functions shown in the figures or described above can be implemented or supported using dedicated hardware components. In general, the functions shown in the figures or described above can be performed using any suitable hardware or any suitable combination of hardware and software/firmware instructions. Also, the functions shown in the figures or described above can be performed by a single device or by multiple devices.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method comprising:
obtaining a raw image;
mapping, using a raw image encoder, the raw image to a compressed domain, wherein the raw image is represented using latent variables in the compressed domain;
performing one or more image signal processing operations on the latent variables, wherein each of the one or more image signal processing operations is configured to operate in the compressed domain, and wherein the one or more image signal processing operations generate processed latent variables; and
mapping, using an output image decoder, the processed latent variables to an output image in an output color space.

2. The method of claim 1, wherein one of:
the output color space is a red-green-blue (RGB) color space and the output image is an RGB image; or
the output color space is a luminance-chrominance (YUV) color space and the output image is a YUV image.

3. The method of claim 1, wherein the raw image comprises a Tetra image, a Bayer image, a hexa-deca image, or a red-green-blue-white (RGBW) image.

4. The method of claim 1, wherein at least one of:
the raw image encoder comprises a convolutional neural network-based encoder with quantization; or
the output image decoder comprises a convolutional neural network.

5. The method of claim 1, wherein the one or more image signal processing operations comprise at least one of: compressed domain denoising, compressed domain sharpening, compressed domain point spread function (PSF) inversion, compressed domain segmentation, compressed domain motion map estimation and motion compensation, or compressed domain motion image registration.

6. The method of claim 1, wherein the raw image encoder comprises a trained machine learning model subjected to a training scheme comprising:
training a teacher image encoder to map input images into the compressed domain, wherein the training yields trained network weights for the teacher image encoder;
initializing network weights of the raw image encoder from the trained network weights for the teacher image encoder; and
constraining outputs of the raw image encoder to be close to outputs of the teacher image encoder via a mean squared error loss in the compressed domain.

7. The method of claim 6, wherein:
the teacher image encoder is a red-green-blue (RGB) image encoder; and
the training scheme comprises training the teacher image encoder to map RGB images into the compressed domain.

8. The method of claim 6, wherein:
the teacher image encoder is a luminance-chrominance (YUV) image encoder; and
the training scheme comprises training the teacher image encoder to map YUV images into the compressed domain.

9. The method of claim 1, wherein mapping the raw image to the compressed domain comprises:
mapping a multi-frame stream of data including the raw image to the compressed domain based on (i) a first frame within the multi-frame stream of data and (ii) at least one of:
spatial redundancy between the first frame and a remainder of frames within the multi-frame stream of data; or
the spatial redundancy between the first frame and the remainder of frames and temporal redundancy between consecutive frames within the multi-frame stream of data; and
wherein the first frame includes the raw image.

10. The method of claim 1, wherein at least one of:
mapping the raw image to the compressed domain comprises ordering data from most significant bits to least significant bits; or
performing the one or more image signal processing operations comprises processing only the most significant bits of data in the compressed domain to perform at least one of the one or more image signal processing operations that does not require full-resolution data.

11. An electronic device comprising:
at least one processing device configured to:
obtain a raw image;
map, using a raw image encoder, the raw image to a compressed domain, wherein the raw image is represented using latent variables in the compressed domain;
perform one or more image signal processing operations on the latent variables, wherein each of the one or more image signal processing operations is configured to operate in the compressed domain, and wherein the one or more image signal processing operations are configured to generate processed latent variables; and
map, using an output image decoder, the processed latent variables to an output image in an output color space.

12. The electronic device of claim 11, wherein one of:
the output color space is a red-green-blue (RGB) color space and the output image is an RGB image; or
the output color space is a luminance-chrominance (YUV) color space and the output image is a YUV image.

13. The electronic device of claim 11, wherein the raw image comprises a Tetra image, a Bayer image, a hexa-deca image, or a red-green-blue-white (RGBW) image.

14. The electronic device of claim 11, wherein at least one of:
the raw image encoder comprises a convolutional neural network-based encoder with quantization; or
the output image decoder comprises a convolutional neural network.

15. The electronic device of claim 11, wherein the one or more image signal processing operations comprise at least one of: compressed domain denoising, compressed domain sharpening, compressed domain point spread function (PSF) inversion, compressed domain segmentation, compressed domain motion map estimation and motion compensation, or compressed domain motion image registration.

16. The electronic device of claim 11, wherein the raw image encoder comprises a trained machine learning model subjected to a training scheme comprising:
training a teacher image encoder to map input images into the compressed domain, wherein the training yields trained network weights for the teacher image encoder;
initializing network weights of the raw image encoder from the trained network weights for the teacher image encoder; and
constraining outputs of the raw image encoder to be close to outputs of the teacher image encoder via a mean squared error loss in the compressed domain.

17. The electronic device of claim 16, wherein:
the teacher image encoder is a red-green-blue (RGB) image encoder or a luminance-chrominance (YUV) image encoder; and
the training scheme comprises training the teacher image encoder to map RGB images or YUV images into the compressed domain.

18. The electronic device of claim 11, wherein:
to map the raw image to the compressed domain, the at least one processing device is configured to map a multi-frame stream of data including the raw image to the compressed domain based on (i) a first frame within the multi-frame stream of data and (ii) at least one of:
spatial redundancy between the first frame and a remainder of frames within the multi-frame stream of data; or
the spatial redundancy between the first frame and the remainder of frames and temporal redundancy between consecutive frames within the multi-frame stream of data; and
the first frame includes the raw image.

19. The electronic device of claim 11, wherein at least one of:
to map the raw image to the compressed domain, the at least one processing device is configured to order data from most significant bits to least significant bits; or
to perform the one or more image signal processing operations, the at least one processing device is configured to process only the most significant bits of data in the compressed domain to perform at least one of the one or more image signal processing operations that does not require full-resolution data.

20. A non-transitory machine readable medium containing instructions that when executed cause at least one processor of an electronic device to:
obtain a raw image;
map, using a raw image encoder, the raw image to a compressed domain, wherein the raw image is represented using latent variables in the compressed domain;
perform one or more image signal processing operations on the latent variables, wherein each of the one or more image signal processing operations is configured to operate in the compressed domain, and wherein the one or more image signal processing operations are configured to generate processed latent variables; and
map, using an output image decoder, the processed latent variables to an output image in an output color space.
